(19) United States
(12) Patent Application Publication
(10) Pub. No.: US 2020/0042104 A1
(43) Pub. Date: Feb. 6, 2020

(54) System and Method for Cognitive User-Behavior Driven Messaging or Chat Applications

(71) Applicant: International Business Machines Corporation, Armonk, NY (US)

(72) Inventors: Joseph N. Kozhaya, Morrisville, NC (US); Anita Govindjee, Ithaca, NY (US); Javier R. Torres, Miami, FL (US)

(21) Appl. No.: 16/054,402

(22) Filed: Aug. 3, 2018

(51) Int. Cl. G06F 3/023; H04L 29/08; G06F 17/27

(52) U.S. Cl. CPC G06F 3/0237; G06F 17/276; H04L 67/22

(57) ABSTRACT

A method, system and a computer program product are provided for interactively adjusting completion option suggestions based on user actions in a word processing application, such as a messaging application, by monitoring user interactions to detect one or more non-selected suggestions from a displayed first set of completion option suggestions for completing a first user message input, reprioritizing the one or more non-selected suggestions to reflect a reduced probability that the one or more non-selected suggestions will be selected by the user, and displaying a second set of one or more completion option suggestions for completing a second user message input, where the second set of one or more completion option suggestions is identified at least in part based on the reprioritized one or more non-selected suggestions.

### BACKGROUND OF THE INVENTION

In the information technology fields, auto-completion (or word completion) techniques are used to suggest or recommend words or phrases that the user is typing so that the user can press a key to accept a suggestion, thereby speeding up human-computer interactions when the computer correctly predicts the word a user intends to enter after only a few characters have been typed into a text input field. For example, many messaging applications include autocomplete algorithms that learn new words after the user has written them a few times, and can suggest alternatives based on the learned habits of the individual user. To make suggestions, messaging applications will typically use language models to access dictionaries in defined domains having a limited number of possible words, where the dictionaries can be augmented based on commonly used words or phrases from the user. However, existing messaging/chat applications do not otherwise account for user behavior and actions when making suggestions. As a result, the existing solutions for efficiently generating auto-completion suggestions are inefficient at a practical level in failing to accurately reflect user behavior, to reduce the number of required keystrokes to complete a word or phrase or otherwise failing to increase the typing speed and speed up user-interaction with applications such as word processors, web browsers, e-mail programs, search engine interfaces, source code editors, database query tools, command line interpreters, and the like.

### SUMMARY

Broadly speaking, selected embodiments of the present disclosure provide a system, method, and apparatus for interactively adjusting auto-completion suggestions based on user behavior in a messaging/chat application by using the cognitive power of the information handling system to present a first set of auto-completion options in response to a one or more characters or words input from the user, to monitor user behavior in response to the first set of auto-completion options to identify one or more non-selected auto-completion options, to downgrade the priority of the non-selected auto-completion option(s), and then present a second set of auto-completion options in response to a second character or word input from the user, where the second set of auto-completion options is generated based on the downgraded priority of the non-selected auto-completion option(s). When downgrading the priority of non-selected auto-completion option(s), the information handling system may assign or compute a probability of acceptance for each auto-completion option, with a lower probability being computed for an auto-completion option that was not selected from the first set of auto-completion options presented to the user. In addition, the information handling system may compute a probability score Pi which indicates the user's likelihood of selecting a suggested word (e.g., Pi=#suggested_words_selected/#words_typed), although one or more additional factors may be used to compute the probability score, such as a length factor for the suggested word to reflect that longer words are more likely to be selected. In monitoring the user behavior, the information handling system may assemble a list of auto-completion options presented to the user in response to each character or word input by the user so that successive first and second lists can be compared to find any intersecting auto-completion options that are included in both lists. Based on intersection analysis, the information handling system assigns a lower probability or priority to the intersecting auto-completion option(s) in the second list and/or moves the intersecting auto-completion option(s) to the bottom of the list or auto-completion options presented to the user.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a system diagram of a distributed data processing network that includes an information handling system that uses a cognitive user-behavior driven messaging application in accordance with selected embodiments of the present disclosure;

FIG. 2 is a block diagram of a processor and components of an information handling system such as those shown in FIG. 1; and

FIG. 3 illustrates a simplified flow chart showing the logic for interactively adjusting auto-completion suggestions based on user behavior in a messaging application in accordance with selected embodiments of the present disclosure.

### DETAILED DESCRIPTION

The present invention may be a system, a method, and/or a computer program product. In addition, selected aspects of the present invention may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present invention may take the form of a computer program product embodied in a computer readable storage medium (or media) having computer readable program instructions thereon for causing a processor to carry out aspects of the present invention. Thus embodied, the disclosed system, a method, and/or a computer program product is operative to improve the functionality and operation of a computer system in providing accurate auto-completion suggestions based on user behavior and actions in responding to auto-completion suggestions.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

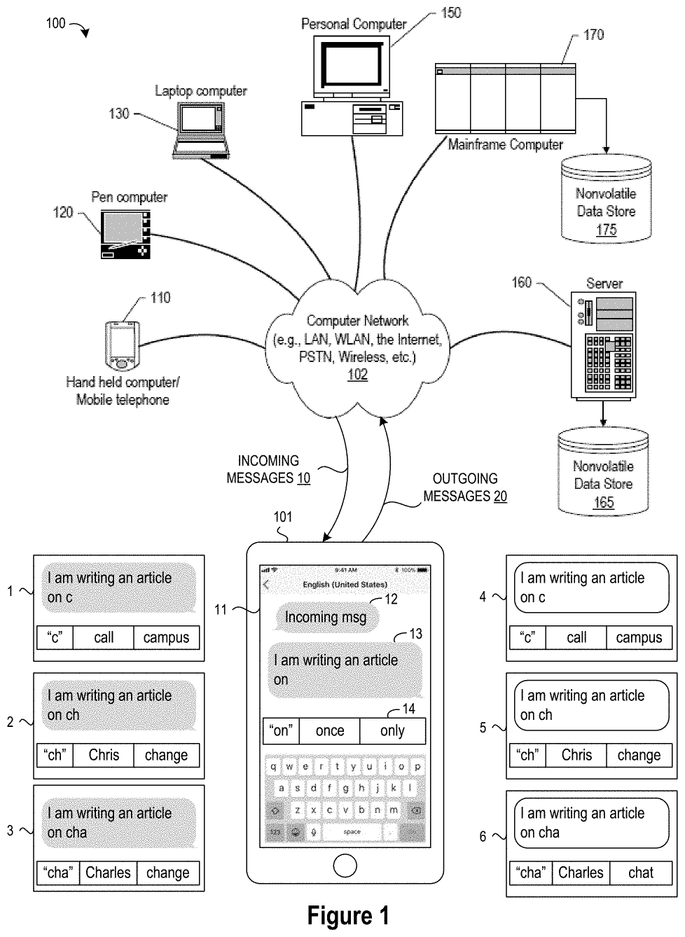

FIG. 1 depicts a schematic diagram of a distributed data processing network, generally designated 100, that includes an information handling system 101 that uses a cognitive user-behavior driven messaging application in accordance with selected embodiments of the present disclosure. FIG. 1 provides only an illustration of selected implementations and does not imply any limitations with regard to the environments in which different embodiments may be implemented. Many modifications to the depicted distributed data processing system may be made by those skilled in the art without departing from the scope of the invention as recited by the claims. In the distributed data processing network 100, the information handling system 101 is connected across a computer network 102 to receive incoming messages 10 and send outgoing messages 20 that are exchanged with one or more users at computing devices, such as a mobile phone 110, pen or tablet computer 120, laptop or notebook computer 130, personal computer system 150, server computer 160 and/or mainframe computer 170. Over the network 102, the computing devices communicate with each other and with other devices or components via one or more wired and/or wireless data communication links, where each communication link may comprise one or more of wires, routers, switches, transmitters, receivers, or the like. The network 102 is the medium used to provide communication links between various devices and computers connected together within distributed data processing network 100, and may include, for example, a telecommunications network, a local area network (LAN), a wide area network (WAN), such as the Internet, or a combination of the three, and includes wired, wireless, and/or fiber optic connections. Network 102 includes one or more wired and/or wireless networks that are capable of receiving and transmitting data, voice, and/or video signals, including multimedia signals that include voice, data, and video information. In this networked arrangement, the information handling system 101 and network 102 may enable question/answer (QA) generation functionality for one or more content users. Other embodiments of distributed data processing network 100 may be used with components, systems, sub-systems, and/or devices other than those that are depicted herein.

As shown in FIG. 1, the information handling system 101 may be embodied as a mobile device, such as an iPhone or Android phone, which includes one or more processors or microcontrollers and associated memory storage devices which are connected and configured to implement a mobile computing functionality, such as a communication device or a wearable device. The configuring of the mobile device 101 may comprise the providing of application specific hardware, firmware, or the like to facilitate the performance of the operations and generation of the outputs described herein with regard to the illustrative embodiments. In addition or in the alternative, the configuring of the mobile device 101 may include storing software applications into the memory of the mobile device 101 for causing one or more hardware processors of the mobile device 101 to execute the software applications that configure the processor(s) to perform the operations and generate the outputs described herein with regard to the illustrative embodiments. Moreover, any combination of application specific hardware, firmware, software applications executed on hardware, or the like, may be used without departing from the spirit and scope of the illustrative embodiments. Thus, selected embodiments of the present disclosure may be implemented at the “device” level or at the “application” level

It should be appreciated that once the mobile device 101 is configured in one of these ways, it becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates efficient human-computer interactions interactively adjusting auto-completion suggestions generated at the mobile device 101 based on user behavior in a messaging/chat application by using the cognitive processing power which monitors user behavior in response to auto-completion suggestions and modifies the priority of the non-selected auto-completion option(s) when used with subsequent auto-completion suggestions.

Though not shown, it will be appreciated that the overall structure of the mobile device 101 includes an input/output interface unit, a network interface unit, a data store unit, and a processing unit. The input/output interface unit is connected and configured to provide a data connection to I/O on the mobile device 101, such as a keyboard, a keypad, a touch screen, display screen and/or some other suitable input/output on the mobile device 101. In addition, the network interface unit is connected and configured to provide a communication link with other data processing systems or devices, such as by providing a network interface card for exchanging data via the network 102. The data store unit may be a separate storage which is separately accessed by individual applications running on the mobile device 101 using one or more APIs. As disclosed herein, the processing unit includes a cognitive computing functionality which is implemented with software and/or hardware resources (e.g., processor(s) and memory) for running a messaging or chat application that understands a user's behavior and augments and/or modifies the suggested auto-completion options of the application based on the user's actions in responding to previously presented auto-completion options. In selected example embodiments, the cognitive power of the processing unit notices when a user does NOT select a word recommended in the auto-completion suggestions, and then de-prioritizes or removes the non-selected word from subsequent auto-completion suggestions, even if the additional characters typed by the user still match that non-selected word. As a result, the messaging/chat application learns from the user's common behavior (e.g., the user typically selects suggested words when correct) and the user's actions (e.g., the user did not select a suggested word) when making its suggestions by removing non-selected word recommendations.

To provide additional details for an improved understanding of selected embodiments of the present disclosure, reference is now made to the screen display 11 which displays an example messaging application which displays an incoming message bubble/panel 12 and an outgoing message bubble/panel 13 along with a suggestion panel 14 of recommended words that are generated by an auto-completion module. In the example, the user has typed part of a message “I am writing an article on” in the outgoing message panel 13 and the suggestion panel 14 displays recommended words (“on”, once, only) relating to the user's most recently entered word (on). If the user's next word to be typed is “chatbot,” then the user's entry of the first character “c” causes the screen display 11 to be updated (as shown with display screen excerpt 1) so that the suggestion panel 14 displays a first set of recommended words (“c”, call, campus) that are generated by an auto-completion module. And when the user enters the next character “h,” this causes the screen display 11 to be updated (as shown with display screen excerpt 2) so that the suggestion panel 14 displays a second set of recommended words (“c”, Chris, change) that are generated by an auto-completion module. Finally, when the user enters the next character “a,” this causes the screen display 11 to be updated (as shown with display screen excerpt 3) so that the suggestion panel 14 displays a third set of recommended words (“c”, Charles, change) that are generated by an auto-completion module. In this example sequence, it can be seen that the suggestion panel 14 continues to recommend the word “change” in the third set of recommended words even though the user did not select it from the second set of recommended words. The repetitive presentation of the same recommended word amounts to an inefficiency in the user-computer interaction, and also wastes valuable space on the screen display 11 in displaying information that is not selected by the user.

To remedy this inefficiency and waste of valuable screen display space, selected embodiments of the present disclosure provide a behavior-driven suggestion engine for the messaging application which monitors the user's behavior in terms of responding the word recommendations and works with the language models to deprioritize a non-selected word (e.g., “change”) to instead recommend other candidate words in the suggestion panel 14. To provide an example, reference is now made to the display screen excerpt 4 which shows the portion of the display screen 11 after the user has typed the first character “c” and the suggestion panel 14 displays a first set of recommended words (“c”, call, campus) that are generated by an auto-completion module. And when the user enters the next character “h,” this causes the screen display 11 to be updated (as shown with display screen excerpt 5) so that the suggestion panel 14 displays a second set of recommended words (“c”, Chris, change) that are generated by an auto-completion module. However, when the user enters the next character “a,” this causes the screen display 11 to be updated (as shown with display screen excerpt 6) so that the suggestion panel 14 displays a third set of recommended words (“c”, Charles, chat) that are generated by an auto-completion module only after re-prioritizing the previously non-selected word “change” so that another word (chat) is instead displayed, thereby preventing the repetitive presentation of the same recommended word. As will be appreciated, the re-prioritization of the non-selected word can be applied within the existing message, but may also be applied when a user types a second, new message so that an auto-suggested word that is not selected in the first message will be de-prioritized further down the suggested word list for the second, new message.

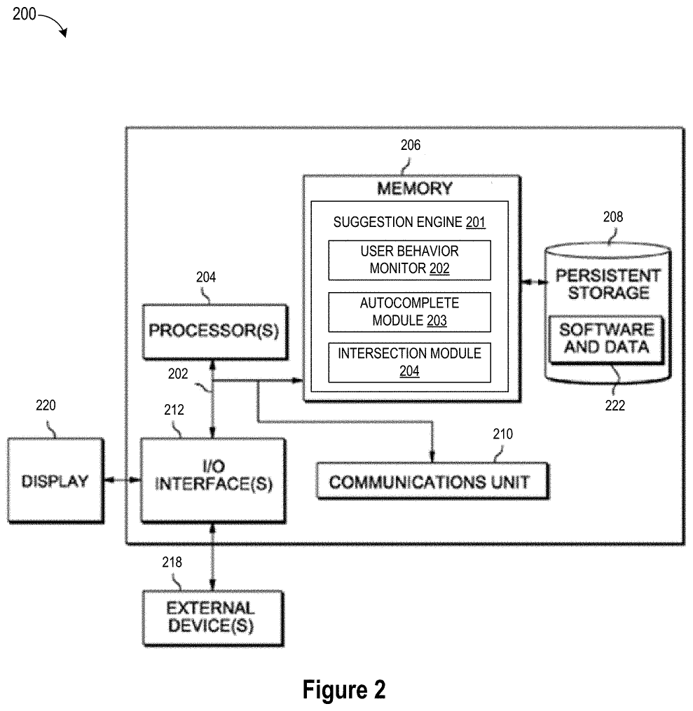

As will be appreciated, the various types of information handling systems can utilize messaging applications which include behavior-driven suggestion engines disclosed herein, such as small handheld devices, computer/mobile telephones, personal digital assistants (PDAs), and personal entertainment devices, such as MP3 players, portable televisions, and compact disc players. Other examples of information handling systems include pen or tablet computers, laptop or notebook computers, personal computer systems, servers, large mainframe computer systems, and the like. An illustrative example of an information handling system showing an exemplary processor and various components commonly accessed by the processor is shown in FIG. 2 which depicts a block diagram of a processor and components of an information handling system 200 capable of performing the computing operations described herein. Information handling system 200 includes one or more processors 204 coupled over a processor interface bus 202 to various internal and external system components. It should be appreciated that FIG. 2 provides only an illustration of selected embodiments and does not imply any limitations with regard to the environments in which different embodiments may be implemented. Many modifications to the depicted environment may be made.

In the depicted example, the information handling system 200 includes communications fabric 202, which provides communications between computer processor(s) 204, memory 206, persistent storage 208, communications unit 210, and input/output (I/O) interface(s) 212. Communications fabric 202 can be implemented with any architecture designed for passing data and/or control information between processors (such as microprocessors, communications, and network processors, etc.), system memory, peripheral devices, and any other hardware components within a system. For example, communications fabric 202 can be implemented with one or more buses.

Memory 206 and persistent storage 208 are computer readable storage media. In this embodiment, memory 206 may include random access memory (RAM) and/or cache memory. In general, memory 206 can include any suitable volatile or non-volatile computer readable storage media. Software and data 222 may be stored in persistent storage 208 for access and/or execution by processor(s) 204 via one or more memories of memory 206. In selected embodiments, the system memory 206 may store a variety of programs, including a behavior-driven suggestion engine module 201 which may be invoked to interactively adjust auto-completion suggestions in a messaging/chat application by monitoring user behavior in responding to presented auto-completion options to identify one or more non-selected auto-completion options so that they are re-prioritized and/or removed in the presentation of subsequent auto-completion options.

In selected embodiments, persistent storage 208 includes a magnetic hard disk drive. Alternatively, or in addition to a magnetic hard disk drive, persistent storage 208 can include a solid-state hard drive, a semiconductor storage device, a read-only memory (ROM), an erasable programmable read-only memory (EPROM), a flash memory, or any other computer readable storage media that is capable of storing program instructions or digital information. The media used by persistent storage 208 may also be removable. For example, a removable hard drive may be used for persistent storage 208. Other examples include optical and magnetic disks, thumb drives, and smart cards that are inserted into a drive for transfer onto another computer readable storage medium that is also part of persistent storage 208.

Communications unit 210, in these examples, provides for communications with other data processing systems or devices. In these examples, communications unit 210 includes one or more network interface cards. Communications unit 210 may provide communications through the use of either or both physical and wireless communications links. Software and data 222 may be downloaded to persistent storage 208 through communications unit 210.

I/O interface(s) 212 allows for input and output of data with other devices that may be connected to computer 200. For example, I/O interface(s) 212 may provide a connection to external device(s) 218, such as a keyboard, a keypad, a touch screen, and/or some other suitable input device. External device(s) 218 can also include portable computer readable storage media such as, for example, thumb drives, portable optical or magnetic disks, and memory cards. Software and data 222 can be stored on such portable computer readable storage media and can be loaded onto persistent storage 208 via I/O interface(s) 212. I/O interface(s) 212 also connect to a display 220 which provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

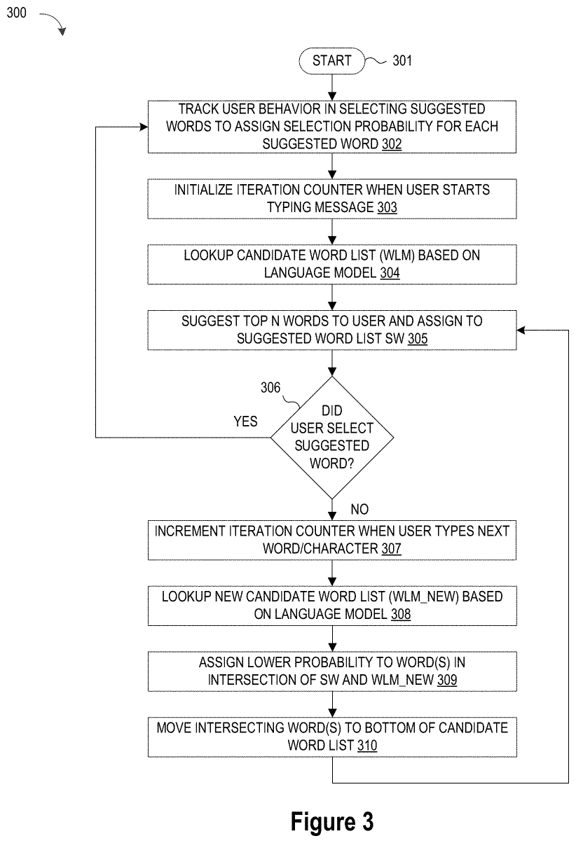

To provide additional details for an improved understanding of selected embodiments of the present disclosure, reference is now made to FIG. 3 which depicts a simplified flow chart 300 showing the logic for interactively adjusting auto-completion suggestions based on user behavior in a messaging application. The processing shown in FIG. 3 may be performed by the mobile device 101 or any other computer system, such as a cognitive system, other natural language question answering system, or the like.

FIG. 3 processing commences at 301 whereupon, at step 302, the user behavior is tracked to monitor how the user responds to auto-completion suggestions in terms of selecting or not selecting suggested auto-completion words presented to the user. For example, a messaging application may use one or more language models to access dictionaries for word suggestions, and may monitor the user responses to auto-completion suggestions to augment the dictionaries based on commonly used words or phrases from the user. At this point, the messaging application may include a dictionary of candidate words that can be suggested or recommended to the user based on the input characters typed by the user when creating a message. In this dictionary, each candidate word may be assigned a probability score which indicates the user's likelihood of selecting the suggested word. While any suitable probability formula may be used, selected embodiments may dynamically compute the selection probability Pi for each word based on user interactions with the auto-completion suggestions when formulating a given message. For example, the probability may be computed by dividing the number of suggested words selected by the user in a given message (#suggested_words_selected) by the number of words in a message that are typed and/or selected by the user (#words_typed) (e.g., Pi=#suggested_words_selected/#words_typed), though additional factors could be included in the probability computation. For example, the length of a suggested word could be used to compute a higher probability for selection for long words and a lower probability for selection for short words. In addition or in the alternative, the computation of the selection probability may be based on a count of how many completion option suggestions were presented and not selected, a count of how many completion option suggestions were presented and selected, and/or a count of how many completed words are entered (e.g., typed and or selected) by the user in a message. The processing at step 302 may be performed at the mobile device 101, or other information handling system having NLP capabilities.

At step 303, one or more iteration counter values are initialized when the user starts typing a message. For example, when the first character of a message is typed, a first iteration counter value “i” is initialized (e.g., i=1), and this value may be incremented with each additional character that is typed by the user. In addition or in the alternative, when the first word of a message is typed, a second iteration counter value “j” is initialized (e.g., j=1), and this value may be incremented with each additional word typed and/or selected by the user.

At step 304, a candidate word list (WLM) is assembled by looking up one or more word recommendations in response to the user's message input. For example, a messaging application may leverage a language model to make auto-completion suggestions based on user-specified message inputs, with the suggested words being assembled into the candidate word list (WLM) based on the language model.

At step 305, the top N words from the candidate word list WLM may be presented as auto-completion suggestions to the user and assigned to a suggested word list (SW). For example, the messaging application may identify N=3 auto-completion suggestions for presentation and display in the suggestion panel portion of the screen display. In addition, the N suggested words may be assigned to a new suggested word list SWi that is created for each iterative counter value i. As will be appreciated, the selection process at step 305 may be driven in part by the selection probability values Pi for each suggested word.

At step 306, the messaging application determines if the user selected one of the words from the suggested word list SW. If a recommended word is selected (affirmative outcome from step 306), then the process returns to step 302 where the user behavior (in selecting a suggested word) is monitored and used to update the selection probability values. However, if no word is selected by the user (negative outcome from step 306), then the appropriate iteration counter is incremented (step 307) for use in tracking the user behavior in response to new suggested word lists. For example, the iterative character counter “i” and/or word counter “j” is incremented when the user types the next character or word.

Once the appropriate counter is incremented, the messaging application looks up a new candidate word list (WLM NEW) (at step 308) and then recalculates the selection probability values (step 309) so that a lower probability is assigned to words that were not selected by the user. For example, each word that intersects (or is present on both) the initial suggested word list (SW) and the new candidate word list (WLM NEW) may be identified as a non-selected word which is then re-prioritized, such as by decrementing or re-computing the selection probability Pi for each non-selected word from the initial suggested word list. In addition or in the alternative, each intersecting or non-selected word may be moved to the bottom of the candidate word list (WLM) and/or new candidate word list (WLM NEW) (step 310). At this point, the methodology returns to step 305 which selects a new set of N words for the suggested word list SW based on the recomputed selection probabilities.

As will be appreciated, the processing at steps 302-310 may be performed at the mobile device 101, or other information handling system having NLP capabilities. In addition, the described methodology 300 is provided with reference to making auto-completion suggestions of textual words for selection by the user. However, it will be appreciated that the present disclosure can be applied to other auto-completion suggestion applications, such as the suggestion of images or gifs or other media message insertions to the user's message.

Selected embodiments of the present disclosure are described with reference to evaluating user behavior in response to auto-completion recommendations for purposes of downgrading or removing non-selected auto-completion recommendations. However, it will be appreciated that the present disclosure may be also be applied to evaluate and respond to a wide variety of user behavior responses to auto-completion recommendations by re-computing the selection probability measure for each candidate suggestion.

By now, it will be appreciated that there is disclosed herein a system, method, apparatus, and computer program product for interactively adjusting completion option suggestions based on user actions in a communication application which receives user message inputs at an information handling system having a processor and a memory. As disclosed, the system, method, apparatus, and computer program product receives a first user message input comprising one or more characters typed by the user, and then displays a first set of one or more completion option suggestions (e.g., word completion options or image options) for completing a first user message input, where each of the first set of one or more completion option suggestions may be selected by the user to complete the first user message input. At the information handling system, user interactions with the communication application (e.g., chat, word processing or messaging application) are monitored to detect one or more non-selected suggestions from the first set of one or more completion option suggestions. The information handling system also reprioritizes the one or more non-selected suggestions to reflect a reduced probability that the one or more non-selected suggestions will be selected by the user. Upon receiving a second user message input which includes the first user message input and an additional character, the information handling system displays a second set of one or more completion option suggestions for completing the second user message input, where the second set of one or more completion option suggestions is identified at least in part based on the reprioritized one or more non-selected suggestions. In selected embodiments, the reprioritization of the non-selected suggestions is performed by computing a selection probability value for each non-selected suggestion based on a count of how many completion option suggestions were presented and not selected. In other embodiments, the reprioritization of the non-selected suggestions is performed by computing a selection probability value for each non-selected suggestion based on a count of how many completion option suggestions were presented and selected. In other embodiments, the reprioritization of the non-selected suggestions is performed by computing a selection probability value for each non-selected suggestion based on a count of how many completed words are entered by the user in a message. In yet other embodiments, the step of reprioritizing the one or more non-selected suggestions that occurs in connection with a first user message results in each non-selected suggestion from the first user message being re-prioritized for completion option suggestions generated in connection with a second user message.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method of interactively adjusting completion option suggestions based on user actions in a communication application which receives user message inputs, the method comprising:
displaying, by an information handling system comprising a processor and a memory, a first set of one or more completion option suggestions for completing a first user message input, where each of the first set of one or more completion option suggestions may be selected by the user to complete the first user message input;
monitoring, by the information handling system, user interactions to detect one or more non-selected suggestions from the first set of one or more completion option suggestions; and
reprioritizing, by the information handling system, the one or more non-selected suggestions in the first set of one or more completion option suggestions to reflect a reduced probability that the one or more non-selected suggestions will be selected by the user.

2. The method of claim 1, further comprising:
receiving, by the information handling system, a second user message input comprising the first user message input and an additional character.

3. The method of claim 2, further comprising:
displaying, by the information handling system, a second set of one or more completion option suggestions for completing the second user message input, where the second set of one or more completion option suggestions is identified at least in part based on the reprioritized one or more non-selected suggestions.

4. The method of claim 1, where the one or more completion option suggestions comprises one or more word completion option suggestions which complete the first user message input.

5. The method of claim 1, where the one or more completion option suggestions comprises one or more image option suggestions which complete the first user message input.

6. The method of claim 1, where reprioritizing the one or more non-selected suggestions comprises computing a selection probability value for each non-selected suggestion based on a count of how many completion option suggestions were presented and not selected.

7. The method of claim 1, where reprioritizing the one or more non-selected suggestions comprises computing a selection probability value for each non-selected suggestion based on a count of how many completion option suggestions were presented and selected.

8. The method of claim 1, where reprioritizing the one or more non-selected suggestions comprises computing a selection probability value for each non-selected suggestion based on a count of how many completed words are entered by the user in a message.

9. The method of claim 1, where reprioritizing the one or more non-selected suggestions that occurs in connection with a first user message results in each non-selected suggestion from the first user message being re-prioritized for completion option suggestions generated in connection with a second user message.

10. An information handling system comprising:
one or more processors;
a memory coupled to at least one of the processors;
a set of instructions stored in the memory and executed by at least one of the processors to interactively adjust completion option suggestions based on user actions in a communication application which receives user message inputs, wherein the set of instructions are executable to perform actions of:
displaying, by the system, a first set of one or more completion option suggestions for completing a first user message input, where each of the first set of one or more completion option suggestions may be selected by the user to complete the first user message input;
monitoring, by the system, user interactions to detect one or more non-selected suggestions from the first set of one or more completion option suggestions; and
reprioritizing, by the system, the one or more non-selected suggestions to reflect a reduced probability that the one or more non-selected suggestions will be selected by the user.

11. The information handling system of claim 10, where the set of instructions are executable to receive a second user message input comprising an additional character.

12. The information handling system of claim 11, where the set of instructions are executable to display, by the system, a second set of one or more completion option suggestions for completing the second user message input, where the second set of one or more completion option suggestions is identified at least in part based on the reprioritized one or more non-selected suggestions.

13. The information handling system of claim 10, where the one or more completion option suggestions comprises one or more word completion option suggestions or image option suggestions which complete the first user message input.

14. The information handling system of claim 10, where the set of instructions are executable to reprioritize the one or more non-selected suggestions by computing a selection probability value for each non-selected suggestion based on a count of how many completion option suggestions were presented and not selected and/or based on a count of how many completion option suggestions were presented and selected and/or based on a count of how many completed words are entered by the user in a message.

15. A computer program product stored in a computer readable storage medium, comprising computer instructions that, when executed by an information handling system, causes the system to interactively adjusting completion option suggestions by performing actions comprising:
displaying, by the system, a first set of one or more completion option suggestions for completing a first user message input, where each of the first set of one or more completion option suggestions may be selected by the user to complete the first user message input;
monitoring, by the system, user interactions to detect one or more non-selected suggestions from the first set of one or more completion option suggestions; and
reprioritizing, by the system, the one or more non-selected suggestions to reflect a reduced probability that the one or more non-selected suggestions will be selected by the user.

16. The computer program product of claim 15, further comprising computer instructions that, when executed by the information handling system, causes the system to perform actions comprising:
receiving, by the system, a second user message input comprising the first user message input and an additional character; and
displaying, by the system, a second set of one or more completion option suggestions for completing the second user message input, where the second set of one or more completion option suggestions is identified at least in part based on the reprioritized one or more non-selected suggestions.

17. The computer program product of claim 15, where the one or more completion option suggestions comprises one or more word completion option suggestions or image option suggestions which complete the first user message input.

18. The computer program product of claim 15, where reprioritizing the one or more non-selected suggestions comprises computing a selection probability value for each non-selected suggestion based on a count of how many completion option suggestions were presented and not selected.

19. The computer program product of claim 15, where reprioritizing the one or more non-selected suggestions comprises computing a selection probability value for each non-selected suggestion based on a count of how many completion option suggestions were presented and selected.

20. The computer program product of claim 15, where reprioritizing the one or more non-selected suggestions that occurs in connection with a first user message results in each non-selected suggestion from the first user message being re-prioritized for completion option suggestions generated in connection with a second user message.
